(19) United States
(12) Patent Application Publication
(10) Pub. No.: US 2017/0300776 A1
(43) Pub. Date: Oct. 19, 2017

(54) IMAGE IDENTIFICATION SYSTEM

(71) Applicant: CANON KABUSHIKI KAISHA, Tokyo (JP)

(72) Inventors: Takahisa Yamamoto, Kawasaki-shi (JP); Masami Kato, Sagamihara-shi (JP); Katsuhiko Mori, Kawasaki-shi (JP); Yoshinori Ito, Tokyo (JP); Osamu Nomura, Yokohama-shi (JP)

(21) Appl. No.: 15/483,501

(22) Filed: Apr. 10, 2017

(30) Foreign Application Priority Data
Apr. 13, 2016 (JP) 2016-080476

(51) Int. Cl. G06K 9/52; G06K 9/62; G06K 9/46

(52) U.S. Cl. CPC G06K 9/52; G06K 9/4604; G06K 9/6202

(57) ABSTRACT

A first arithmetic apparatus performs an arithmetic process, out of a plurality of arithmetic processes in identification processing on an input image, in which the parameter amount that is used is small compared to an amount of data to which the parameters are applied. A second arithmetic apparatus performs an arithmetic process, out of the plurality of arithmetic processes, in which the parameter amount that is used is large compared to an amount of data to which the parameters are applied. The second arithmetic apparatus can use a larger memory capacity memory than the first arithmetic apparatus.

### BACKGROUND OF THE INVENTION

### Field of the Invention

The present invention is something that relates to a technique of identifying an image.

### Description of the Related Art

A multi-layer neural network called a deep net (also called a deep neural net and deep learning) has attracting a great deal of attention in recent years. A deep net is not something that means a specific arithmetic method, but rather typically means something that performs hierarchical processing (makes a processing result of a particular layer be the input of processing of a subsequent stage layer) on input data (for example, image data).

In particular, in the field of image identification, a deep net configured from convolutional layers for performing convolution filter computations and fully-connected layers for performing fully-connected computations has become mainstream. In such a deep net, it is typical to arrange a plurality of convolutional layers for a first half of processing and to arrange a plurality of fully-connected layers for a second half of processing (Krizhevsky, A., Sutskever, I. and Hinton, G. E. “ImageNet Classification with Deep Convolutional Neural Networks” NIPS 2012).

An example of a convolution filter computation is described using FIG. 4. In FIG. 4, the reference numeral 401 denotes an image to be processed, and the reference numeral 402 denotes a filter kernel. FIG. 4 illustrates a case in which a computation is performed with a filter whose kernel size is 3×3. In such a case, a convolution filter computation result is calculated by a sum-of-products computation process described in the following equation.

$${f}_{i , j} = {\sum }_{s = 1}^{rowSize} {\sum }_{t = 1}^{column Size} ( {d}_{i + s - 1 , j + t - 1} \times {w}_{s , t} ) \qquad ( 1 )$$

Here, d_{i,j} indicates a pixel value at pixel position (i, j) on the image to be processed 401, and f_{i,j} indicates a filter computation result at the pixel position j). Also, w_{s,t} represents a value (filter coefficient parameter) of the filter kernel 402 that is applied to the pixel value at the pixel position (i+s−1, j+t−1). Also, “columnSize” and “rowSize” represent the size of the filter kernel 402 (the number of columns and the number of rows respectively). It is possible to obtain a convolution filter computation output result by performing the foregoing computation while causing the filter kernel 402 to move within the image to be processed 401.

A convolutional layer is configured from non-linear transformation processing as typified by the convolution filter computation and a sigmoid transform. By repeatedly performing convolutional layer computations on input data hierarchically, feature amounts that represent features of an image can be obtained.

In a fully-connected layer arranged following a plurality of convolutional layers in a deep net, a matrix product computation as described in the following equation is performed on an output result of the final convolutional layer (feature amounts).

$$C = A \times B = [ \begin{matrix}{a}_{1} & … & {a}_{m}\end{matrix} ] [ \begin{matrix}{b}_{1 , 1} & … & {b}_{1 , n} \\ ⋮ & ⋱ & ⋮ \\ {b}_{m , 1} & … & {b}_{m , n}\end{matrix} ] \qquad ( 2 )$$

Here, the m-dimension vector A is a vector of feature amounts which is the output from the final convolutional layer, and an m×n matrix B is weighting parameters of the fully-connected layer. An n-dimension vector C, which is the computation result, is a result of a computation of a matrix product between the vector A and the matrix B.

A fully-connected layer is configured from non-linear transformation processing as typified by a sigmoid transform and this matrix product computation. A final identification result is obtained by repeatedly performing the matrix product computation hierarchically on the feature amounts output from the convolutional layer.

Here, in the foregoing convolution filter computation and matrix product computation, the requirements of the platform on which the computations are executed are quite different. Below, these are described in detail.

It is possible to treat a convolution filter computation and a matrix product computation as the same type of computation in the sense that they are computations of the dot product of input data and parameters. In the case of the convolution filter computation, the input data is an input image or the previous convolutional layer output result, and the parameters are filter coefficient parameters. Similarly, in the case of the matrix product computation, input data is feature amounts output from the final convolutional layer or the fully-connected layer output result of the previous layer, and the parameters are the fully-connected layer weighting parameters. In this way, both computations are the same type of computation in the sense that they are computations of the dot product of input data and parameters, but the characteristics of the two computations are very different.

In a convolution filter computation performed in a convolutional layer, computation is performed while causing the filter kernel to move within the image as described above. That is, it is possible to extract partial data (a partial image extracted by a scan window) from the input image at each position of the filter kernel (scan position), and to obtain a computation result at each position by performing the foregoing computation using the partial data and the filter kernel.

In contrast to this, in the matrix product computation performed in the fully-connected layer, a computation that multiplies the matrix configured by the weighting parameters with the input data (feature amounts) arranged in vector form is performed. That is, it is possible to obtain each vector element of the computation result by extracting a column vector of the matrix of weighting parameters and performing a computation with the input data and the extracted column vector.

To summarize the above, there is the following difference in the computation characteristics defined by the input data amount and the parameter amount between the convolutional layer convolution filter computation and the fully-connected layer matrix product computation. Specifically, in the convolution filter computation, a convolution filter computation result is obtained by applying the same filter kernel to each of a plurality of partial set data items of the input data. Accordingly, the amount of the filter kernel (filter coefficient parameters) is low compared to the input data amount.

In contrast to this, in the matrix product computation, a matrix product computation result is obtained by applying each of a plurality of partial sets (column vectors) of weighting coefficient parameters (matrix) to the same input data. Accordingly, the amount of the weighting coefficient parameters is large compared to the input data amount.

Also, in the convolution filter computation and the matrix product computation, the computation amount is proportional to the input data amount. It can be said that in the convolution filter computation, the product of the size of the filter kernel with the input data amount (the size of the input image) is the computation amount. Accordingly, the computation amount of the convolution filter computation is proportional to the input data amount (processing for the edges of the input image being ignored). Similarly, it can be said that in the matrix product computation, the product of the number of columns of the weighting coefficient parameter matrix (the number of column vectors) and the input data amount is the computation amount. Accordingly, the computation amount of the computation of a matrix product is proportional to the input data amount.

From this, the following can be said about the computation characteristics in the convolutional layer convolution filter computation and the fully-connected layer matrix product computation. In other words, for the convolution filter computation, it can be said that the amount of the filter kernel (filter coefficient parameters) is small compared to the computation amount, and for the matrix product computation is can be said that the amount of the weighting coefficient parameters is large compared to the computation amount.

As described above, it can be seen that in the arithmetic processing in the deep net are included two computations (a convolution filter computation in a convolutional layer and a fully-connected computation in a fully-connected layer) whose computation characteristics defined by an input data amount and a parameter amount are respectively different.

In a convolution filter computation in a convolutional layer and a matrix product computation in a fully-connected layer, the processing amount is large because it is necessary to perform a large number of product sum computations, and so it is processing for which the processing time is long. Also, regarding memory that stores the weighting parameters that are necessary for the matrix product computation and the filter kernel necessary for the convolution filter computation, a larger capacity memory is required when there are a large number of layers in the deep net (the number of convolutional layers and the number of fully-connected layers).

Accordingly, typically, abundant computation resources are necessary for deep net processing, and in contrast to a PC (Personal Computer), a server, a cloud or the like, processing on an embedded device whose computation resources are poor has not been considered thus far. In particular, performing a sequence of deep net computations including matrix product computations of the fully-connected layer, for which the parameter amount is large, in an embedded device was not realistic from the perspective of memory capacity allowed in an embedded device. Also, there is the possibility that when similarly performing a sequence of deep net computations including a convolutional layer convolution filter computation for which the computation amount is large on a PC, a server, a cloud or the like, computation resources of these will be pressed.

In Japanese Patent Laid-Open No. H10-171910, the number of connections (the number of parameters) are reduced by executing computations by breaking down a two dimensional neural network into two one-dimensional neural networks. However, in the method disclosed in Japanese Patent Laid-Open No. H10-171910, a sequence of computations configured from computations having a plurality of computation characteristics are divided considering each of the computation characteristics, and performing the processing in processing platforms that are appropriate for each computation is not considered. That is, as described in detail thus far, there is a difference in the computation characteristics between the convolution filter computation and the matrix product computation, but changing the processing platform in accordance with these computation characteristics was not considered.

Also, when all of the sequence of deep net computations is performed on a server, a cloud or the like, it is necessary to transmit the image from a capturing device that captures an image to a server, a cloud, or the like that performs the deep net computations. From the perspective of using a transmission channel effectively, it is advantageous to reduce the data amount of the image that is transmitted. However, thus far, performing deep net computation and reducing the data amount of an image that is transmitted are handled separately, and a method having good overall efficiency has not been studied.

In WO2013/102972 is disclosed a method in which, with the objective of privacy protection, feature amount extraction from an image is performed in an image capturing terminal, extracted feature amounts are transmitted to a server, and a person position in an image is specified. However, this method does not distribute processing that is performed on the capturing terminal and the server considering respective computation characteristics. Accordingly, in the method of WO2013/102972, neither using computation resources efficient nor flexibility or the like at a time of changing an application (an application for which person position specification is envisioned in WO2013/102972) were considered.

### SUMMARY OF THE INVENTION

The present invention was conceived in view of these kinds of problems, and provides a technique for processing in appropriate processing platforms respective computations whose computation characteristics, which are defined by an input data amount and a parameter amount, differ.

According to the first aspect of the present invention, there is provided an image identification system, comprising: a first arithmetic apparatus configured to perform an arithmetic process, out of a plurality of arithmetic processes in identification processing on an input image, in which a parameter amount that is used is small compared to an amount of data to which the parameter is applied, and a second arithmetic apparatus configured to perform an arithmetic process, out of the plurality of arithmetic processes, in which the parameter amount that is used is large compared to an amount of data to which the parameter is applied, wherein the second arithmetic apparatus can use a larger memory capacity memory than the first arithmetic apparatus.

Further features of the present invention will become apparent from the following description of exemplary embodiments (with reference to the attached drawings).

### BRIEF DESCRIPTION OF THE DRAWINGS

FIG. 1 is a block diagram illustrating an example of a configuration of an image identification system.

FIG. 2 is a view illustrating an example of a deep net computation.

FIG. 3 is a block diagram illustrating an example of a configuration of an image identification system.

FIG. 4 is a view illustrating an example of a convolution filter computation.

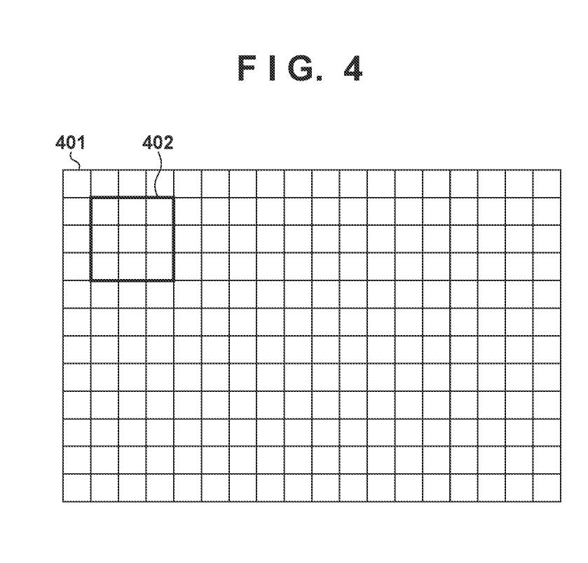

FIG. 5 is a block diagram illustrating an example of a configuration of an image identification system.

### DESCRIPTION OF THE EMBODIMENTS

Below, explanation will be given for embodiments of present invention with reference to the accompanying drawing. Note that embodiments described below merely illustrate examples of specifically implementing the present invention, and are only specific embodiments of a configuration defined in the scope of the claims.

### First Embodiment

In the present embodiment, description is given of an example of an image identification system for realizing, flexibly and at low cost, processing for a deep net in which there is a large computation amount and parameter amount. Also, in the present embodiment, the sequence of deep net processes (except for the foregoing non-linear transformation processing) is divided into two types of computations (first and second computations) according to different computation characteristics defined by the amount of input data (or the computation amount in a proportional relationship with the input data amount) and the amount of parameters. Also, these two types of computations are configured to be executed in processing platforms in accordance with the computation characteristics (first computation characteristic, second computation characteristic) of the respective computations.

In the present embodiment, as the first computation, a computation for which the amount of the parameters is small compared to the amount of the input data is considered, and as the second computation, a computation for which the amount of the parameters is large compared to the amount of the input data is considered. Here, the first computation characteristic is the computation characteristic that “the amount of the parameters is small compared to the amount of the input data”, and the second computation characteristic is the computation characteristic that “the amount of the parameters is large compared to the amount of the input data”.

As described in detail in the “background technology” section, a convolution filter computation in a convolutional layer in the computations in the sequence of deep net processes corresponds to the first computation. This is because the convolution filter computation is a computation that obtains a computation result at each scan position by, at each scan position, extracting partial data (a partial image) from the input image, and performing the foregoing computation with the extracted partial data and the filter kernel. That is, the first computation in such a case is a computation between the same filter kernel and each of the plurality of partial data items that are extracted.

Also, a matrix product computation in a fully-connected layer corresponds to the second computation. This is because the matrix product computation is a computation in which it is possible to obtain each vector element of the computation result by extracting a column vector of the matrix of weighting parameters and performing the foregoing computation with the input data and the extracted weighting parameters.

In the present embodiment, description is given of an example of a case in which, as described above, a convolution filter computation in a convolutional layer is made to be the first computation which has the first computation characteristic, and a matrix product computation in a fully-connected layer is made to be the second computation which has the second computation characteristic. Additionally, in the present embodiment, description is given of an example of a case when the first computation is performed by an embedded device, and the second computation is performed by a computer apparatus (an apparatus that can use memory of a memory capacity that is more abundant at least than the embedded device) such as a PC (personal computer), or a server. As the embedded device, hardware dedicated to computation in an image capturing device (for example, a camera) is envisioned.

Commonly, the hardware envisioned for the embedded device is designed to process specific computations at high speed. Accordingly, it is possible to use a publicly known technique (for example, Japanese patent No. 5184824, or Japanese patent No. 5171118) for producing hardware to process the convolution filter computation efficiently.

However, it is difficult to store a large amount of parameters in the embedded device. In order to store a large amount of parameters a large capacity memory becomes necessary. However, it is commonly difficult to prepare such a large capacity memory in an embedded device for which a circuit area and a mounting area are limited. Also, from the perspective of cost, it is not realistic to prepare a large capacity memory inside an image capturing device such as a camera. That is, it is desirable that the computations in the embedded device be computations for which the amount of the parameters needed for the computation is small. Conversely, it can be said that it is unrealistic to perform computations for which the parameter amount is large in the embedded device.

In contrast to this, in a general-purpose computer (a PC, a cloud, or the like), as typified by a server, it is common that a large capacity memory is mounted or can be used. Accordingly, it can be said that it makes sense to perform computations for which the parameter amount is large on a server.

In the present embodiment, a computation characteristic (size of the parameter amount or the like) of the computation and a characteristic of the computation platform (how realistic it is to mount a large capacity memory) are considered, and assignment to the computation platform of the respective computations in the sequence of deep net processes is conducted. By this, deep net processing is realized at low cost.

In the present embodiment, something that is configured to use a convolution filter computation in processing for extracting feature amounts from an image, and use a matrix product computation as typified by a perceptron in identification processing that uses the extracted feature amounts is assumed to be a typical deep net. This feature amount extraction processing is often multi-layer processing in which a convolution filter computation is repeated a number of times, and there are cases in which a fully-connected multi-layer perceptron is used in the identification processing. This configuration is a very typical configuration as a deep net researched actively in recent years.

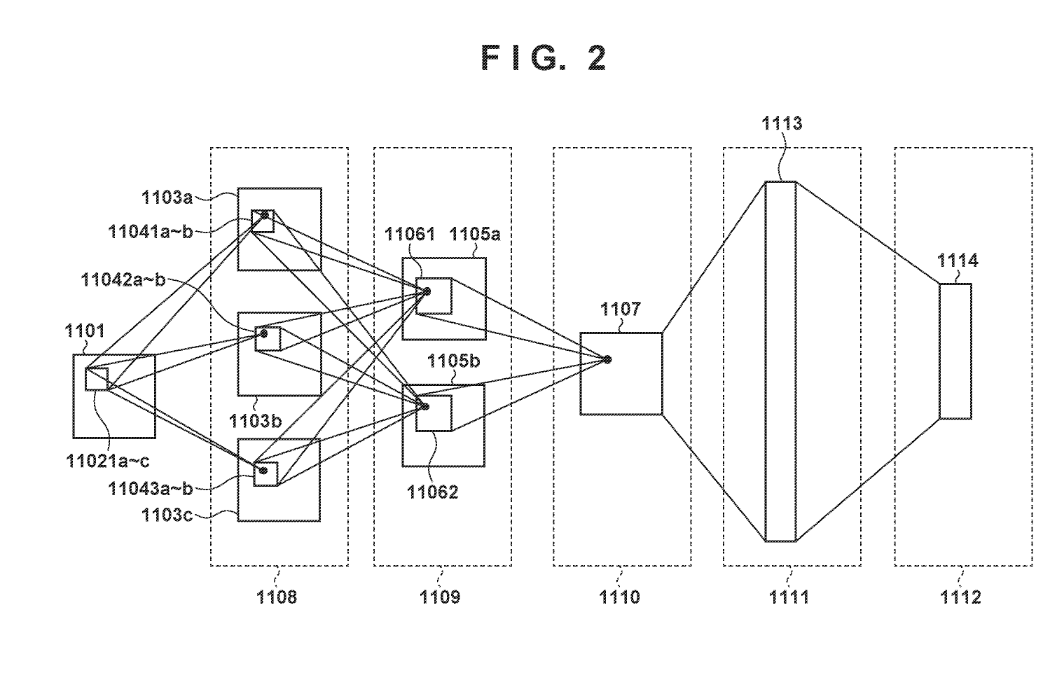

Here, description is given of an example of computation of the deep net using FIG. 2. In FIG. 2 is illustrated processing for obtaining an identification result 1114 by obtaining feature amounts 1107 by performing a feature extraction by a convolution filter computation on an input image 1101 inputted to an input layer, and performing identification processing on the obtained feature amounts 1107. The convolution filter computation to obtain the feature amounts 1107 from the input image 1101 is repeated a number of times. Also, the fully-connected perceptron processing is performed a plurality of times on the feature amounts 1107 to obtain the final identification result 1114.

Firstly, the first half convolution filter computation is described. The feature planes 1103a-1103c are feature planes of a first stage layer 1108. A feature plane is a data plane that indicates a detection result of a predetermined feature extraction filter (convolution filter computation and nonlinear processing). The feature planes 1103a-1103c are generated by a convolution filter computation and the foregoing nonlinear processing on the input image 1101. For example, the feature plane 1103a is obtained by a convolution filter computation using a filter kernel 11021a and a non-linear transformation of the result of the computation. Note that each of the filter kernel 11021b and 11021c in FIG. 2 is a filter kernel used when respectively generating the feature planes 1103b and 1103c.

Next, description is given of a computation for generating a feature plane 1105a of a second stage layer 1109. The feature plane 1105a connects the three feature planes 1103a-1103c of the previous stage layer 1108. Accordingly, if data of the feature plane 1105a is calculated, a convolution filter computation using a kernel indicated by the filter kernel 11041a is performed on the feature plane 1103a, and the result thereof is held. Similarly, a convolution filter computation of each of the filter kernel 11042a and 11043a is performed on the feature plane 1103b and 1103c, and the results of these are held. After these three types of filter computations end, the respective filter computation results are added, and non-linear transformation processing is performed. By processing the whole image with the above processing, the feature plane 1105a is generated. In the generation of the feature plane 1105b, similarly, three convolution filter computations according to the filter kernels 11041b, 11042b, and 11043b are performed on the feature planes 1103a-1103c of the layer 1108, the respective filter computation results are added, and the non-linear transformation processing is performed.

Also, at a time of generation of the feature amounts 1107 of a third stage layer 1110, the two convolution filter computations according to the filter kernels 11061 and 11062 are performed on the feature planes 1105a-1105b of the previous stage layer 1109.

Next, the second half perceptron processing will be described. In FIG. 2, it is a two-layer perceptron. The perceptron is something that performs a non-linear transformation on a weighted sum in relation to the respective elements of the input feature amounts. Accordingly, it is possible to perform a matrix product computation on the feature amounts 1107, and obtain an intermediate result 1113 if a non-linear transformation is performed on the result. Additionally, if similar processing is repeated, it is possible to obtain a final identification result 1114.

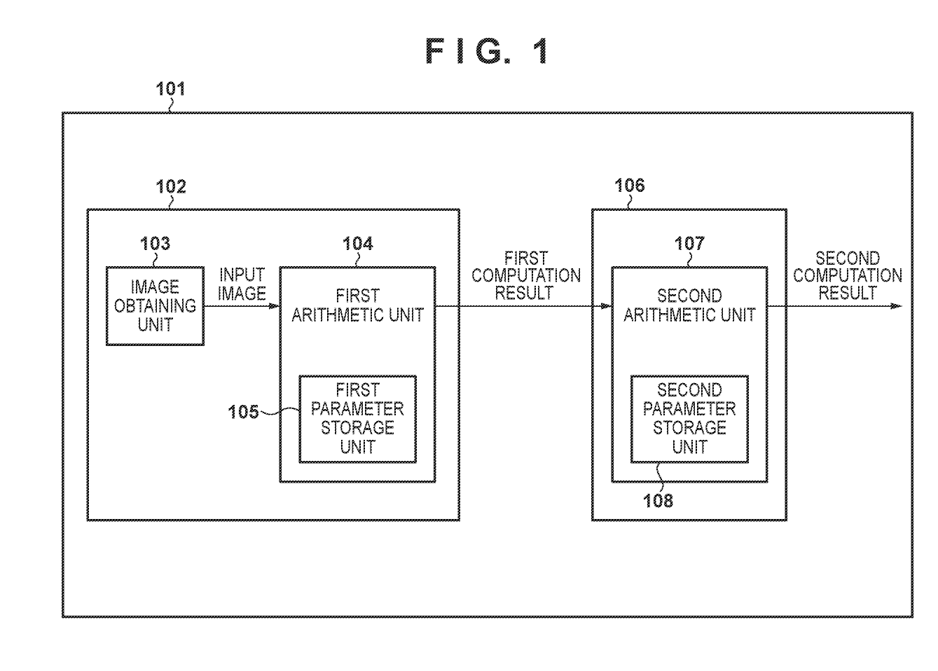

Next, a block diagram of FIG. 1 is described using an example of a configuration of an image identification system that performs image identification using the deep net of FIG. 2. As illustrated in FIG. 1, the image identification system 101 according to the present embodiment has an image capturing device 102 such as a camera and an arithmetic apparatus 106 such as a server, a PC or the like. Also, the image capturing device 102 and the arithmetic apparatus 106 are connected to be able to perform data communication with each other by wire or wirelessly.

The image identification system 101 is something that performs a computation using a deep net on a captured image that an image capturing device 102 captured, and identifies what appears in that captured image as the result (for example, a person, an airplane, or the like).

Firstly, the image capturing device 102 is described. The image capturing device 102 captures an image, and in relation to the image, outputs to the subsequent stage arithmetic apparatus 106 the result of the processing of the first half in the image identification processing realized by the foregoing deep net, specifically the convolution filter computation and the non-linear transformation.

An image obtaining unit 103 is configured by an optical system, a CCD, an image processing circuit, or the like, and converts light of the external world into a video signal, and generates an image based on the converted video signal as a captured image, and outputs the generated captured image as an input image to the first arithmetic unit 104 of the subsequent stage.

A first arithmetic unit 104 is configured by an embedded device (for example, dedicated hardware) comprised in the image capturing device 102, and performs a convolution filter computation and a non-linear transformation on an input image received from the image obtaining unit 103, and extracts feature amounts. By this, realistic processing for processing resources is made possible. The first arithmetic unit 104 is a known embedded device as described above, and the specific configuration thereof can be realized by a publicly known technique (for example, Japanese patent No. 5184824 or Japanese patent No. 5171118).

In a first parameter storage unit 105, parameters (filter kernel) that the first arithmetic unit 104 uses in the convolution filter computation are stored. As described multiple times thus far, the convolution filter computation has the computation characteristic that the parameter amount is small compared to the input data (or a computation amount proportional thereto), and therefore it is possible to store a filter kernel even in the memory of the embedded device.

The first arithmetic unit 104 calculates the feature amounts from the input image by performing the convolution filter computation a number of times using the filter kernel stored in the first parameter storage unit 105 and the input image. That is, the convolution filter computations until the feature amounts 1107 of FIG. 2 is calculated are performed in the first arithmetic unit 104. The first arithmetic unit 104 transmits to the arithmetic apparatus 106 the calculated feature amounts 1107 as a first computation result.

Next, the arithmetic apparatus 106 is described. The arithmetic apparatus 106 outputs a result of the processing of the second half in the image identification processing realized by the foregoing deep net, specifically the fully-connected computation and the non-linear transformation, on the first computation result transmitted from the image capturing device 102.

A second arithmetic unit 107 is realized by a general-purpose computing device comprised in the arithmetic apparatus 106. In a second parameter storage unit 108 are stored parameters that the second arithmetic unit 107 uses in the fully-connected computation, specifically parameters necessary in the matrix product computation (weighting coefficient parameters). As described above, because it is common to mount a large capacity memory to the arithmetic apparatus 106, it is very logical to perform a computation (matrix product computation) having the second computation characteristic, which is that the parameter amount is large, on the arithmetic apparatus 106 side (the second arithmetic unit 107).

The second arithmetic unit 107 calculates the final identification result by performing a matrix product computation a number of times using the first computation result transmitted from the image capturing device 102 and weighting coefficient parameters stored in the second parameter storage unit 108. That is, a matrix product computation until the final identification result 1114 is calculated from the feature amounts 1107 of FIG. 2 is performed by the second arithmetic unit 107. In the present embodiment, because deep net processing that identifies what appears in an input image is performed, an identification class label such as person or airplane is outputted as the final identification result.

Note that there is no limitation to a specific output destination or output format for the output destination and the output format of the identification result by the second arithmetic unit 107. For example, an image, text or the like may be displayed on a display device such as a display for the identification result, and the identification result may be transmitted to an external device, and the identification result may be stored in a memory.

In this way, by virtue of the present embodiment, it is possible to configure the image identification system at a low cost by dividing the deep net processing, which includes a plurality of computations having respectively different computation characteristics, so as to conduct the processing in computation platforms suitable to the respective computation characteristics.

Also, in the convolutional layers in the deep net, it is common to make the feature plane size smaller for progressive layers by sub-sampling (increasing the stride at which the convolution filter computation scan window moves), pooling (integrating with adjacent pixels) or the like. Accordingly, the size of the feature amounts 1107 may be smaller than the size of the input image 1101 of FIG. 2 (the deep net described in: Krizhevsky, A., Sutskever, I. and Hinton, G. E. “ImageNet Classification with Deep Convolutional Neural Networks”, NIPS, 2012, for example). Accordingly, the data amount transmitted will be smaller when the feature amounts are extracted from the input image in the image capturing device 102 and the extracted feature amounts are sent to the arithmetic apparatus 106 than when the input image itself is sent from the image capturing device 102 to the arithmetic apparatus 106. That is, it can be said that the present embodiment is effective from the perspective of efficient communication path usage.

Also, the computation of the convolutional layers performed in the first half of the deep net is commonly called feature amount extraction processing. The feature amount extraction processing is often independent of the application (the image identification task to be realized using the deep net) and can be common. Actually, the feature amount extraction processing portion (the convolutional layer portion) of the deep net described in Krizhevsky, A., Sutskever, I. and Hinton, G. E. “ImageNet Classification with Deep Convolutional Neural Networks”, NIPS, 2012 is often used among each kind of task (Ali Sharif Razavian, Hossein Azizpour, Josephine Sullivan, Stefan Carlsson, “CNN Features off-the-shelf: an Astounding Baseline for Recognition”). That is, by simply changing the configuration (weighting coefficient parameters, network configuration) of the fully-connected layers, leaving the configuration (filter kernel, network configuration) of the convolutional layers as is, it is possible to realize switching between applications.

Accordingly, the following effect is achieved if, as in the present embodiment, the computation platform for performing the convolutional layer computations and the computation platform for performing the fully-connected layer computations are separated. Specifically, it is possible to realize each type of application simply by changing the settings (weighting coefficient parameters, network configuration) of the fully-connected layer computation platform.

Also, it is possible to realize switching and addition of each type application simply by changing the arithmetic apparatus 106 side in an image identification system having the image capturing device 102 and the arithmetic apparatus 106, as in the present embodiment. Commonly, it is extremely cumbersome to change the settings of the image capturing device 102. Here, being able to switch applications and add new applications without effort can be said to be a very useful advantage in maintaining and extending the image identification system, and is highly flexible.

### Second Embodiment

In the present embodiment, description is given of an image identification system in which a plurality of image capturing devices 102 are connected to be able to communicate with the arithmetic apparatus 106, and each of the plurality of image capturing devices 102 transmits feature amounts to the arithmetic apparatus 106. Predominantly differences with the first embodiment are described in the embodiments below, including the present embodiment, and anything that is not touched upon particularly below should be assumed to be the same as in the first embodiment.

Where a plurality of cameras are prepared, an application for specifying what is appearing in an image based on respective images captured by the plurality of cameras is common in a monitoring camera. For example, in an entry/exit management application, capturing a person requesting permission to enter/exit by a plurality of cameras, and identifying an ID of the target person from the image is performed.

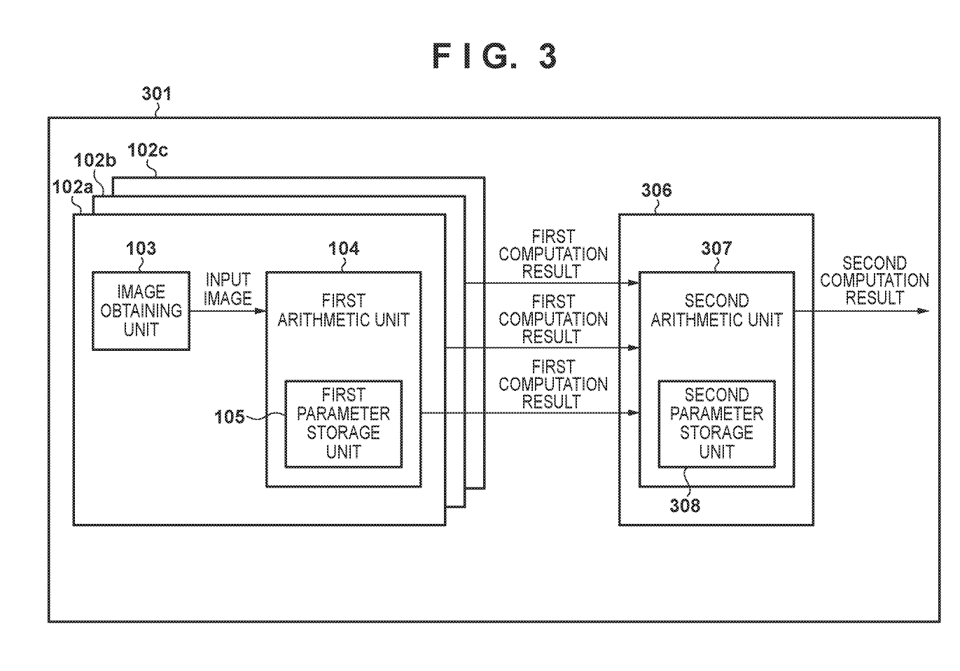

Description of an example of a configuration of the image identification system according to the present embodiment is given using a block diagram of FIG. 3. As illustrated in FIG. 3, in an image identification system 301 according to the present embodiment, a plurality of image capturing devices 102a-102c are connected to be able to communicate with an arithmetic apparatus 306. The a, b, and c added to the reference numeral 102 of the image capturing devices are added to identify each image capturing device, and the image capturing devices 102a-102c all have a similar configuration to the image capturing device 102 of FIG. 1, and perform similar operations. Note that the number of image capturing devices in FIG. 3 is three, but there is no limitation to this number.

Next, description is given for the arithmetic apparatus 306. A second arithmetic unit 307 is realized by a general-purpose computing device comprised in the arithmetic apparatus 306. The second arithmetic unit 307 performs a matrix product computation and a non-linear transformation when it receives a first computation result from each of the image capturing devices 102a-102c, specifies identification information (for example, an ID) of a target person from the images captured by the respective image capturing devices 102a-102c, and outputs it. In the present embodiment, since the first computation results is received from each of the image capturing devices 102a-102c, the second arithmetic unit 307 connects these to generate new feature amounts, and performs a matrix product computation on the feature amounts. A second arithmetic unit 307 is realized by a general-purpose computing device comprised in the arithmetic apparatus 306.

In a second parameter storage unit 308 is stored parameters (weighting coefficient parameters) that are necessary in the matrix product computation that the second arithmetic unit 307 performs. In the present embodiment, because the matrix product computation is performed on feature amounts that connect three first computation results as described above, the amount of the weighting coefficient parameters stored in the second parameter storage unit 308 is that much larger.

In the second arithmetic unit 307, a final identification result is calculated by performing the matrix product computation a number of times using the plurality of first computation results and weighting coefficient parameters stored in the second parameter storage unit 308. In the present embodiment, because processing for specifying identification information (a name, or the like) of a person appearing in the image is performed, identification information specifying a person is outputted as a final identification result.

In the present embodiment, the computation platform for performing the convolutional layer computation and the computation platform for performing the fully-connected layer computation in the deep net are separated. By configuring in this way, not only it is possible to select the computation platform that is suitable for each computation characteristic, and as described in the present embodiment, it leads to realizing an image identification system that can handle adding a plurality of the image capturing devices flexibly. For example, in an image identification system in which all deep net processes are performed in the image capturing device, all processes are completed by the image capturing device if there is only one image capturing device, but it is necessary to integrate the plurality of processing results if there are a plurality of image capturing devices. It is difficult to say that this is a flexible system.

### Third Embodiment

While the final identification result is calculated by the second arithmetic unit in the first and second embodiments, the result calculated by the second arithmetic unit may be returned to the first arithmetic unit again, and the final identification result may be then calculated in the first arithmetic unit. With such a configuration, it becomes possible to consider settings specific to each image capturing device, information when capturing an image in the image capturing device or a preference of the user that operates the individual image capturing device in estimating the final identification result. Also, the breadth of the image identification applications that use the deep net widens.

For example, consider a case of realizing an application for performing a log in authentication using a facial image by a deep net in a smart phone or the like. In such a case, a facial image of a user is captured by an image capturing device integrated in a smart phone, the convolutional layer computations are performed on the facial image to calculate feature amounts (first computation result), and those are sent to an arithmetic apparatus. The fully-connected layer computations are performed on the arithmetic apparatus, high-order feature amounts (second computation result) are then calculated, and those are sent back to the image capturing device once again. In the image capturing device, high-order feature amounts registered in advance and high-order feature amounts sent back from the arithmetic apparatus this time are compared, and it is determined whether to permit the log in.

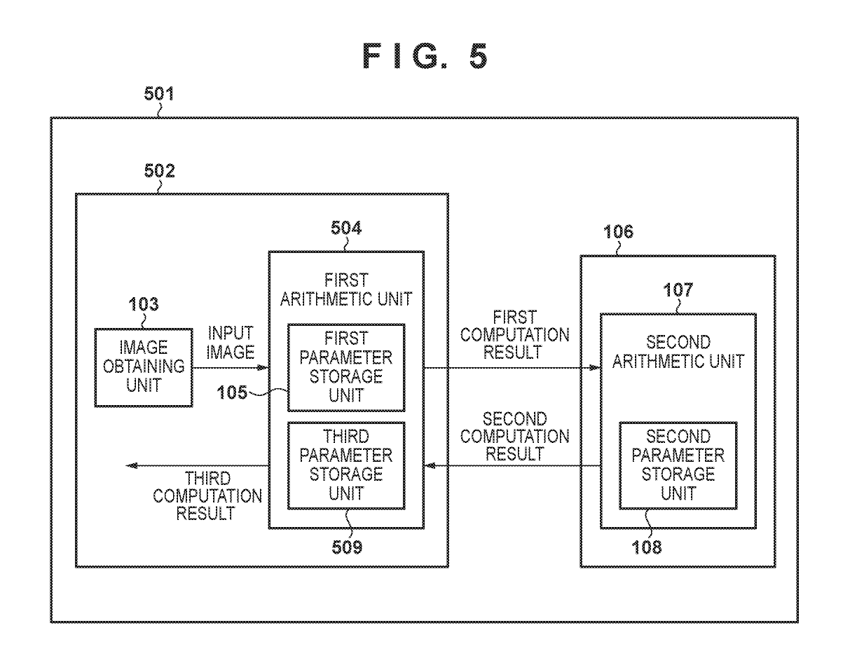

Description of an example of a configuration of the image identification system is given using a block diagram of FIG. 5. An image identification system 501 according to the present embodiment has an image capturing device 502 and the arithmetic apparatus 106, and these are respectively connected to be able to perform data communication with each other, as illustrated in FIG. 5. The second arithmetic unit 107, when it calculates a second computation result, transmits the second computation result to the image capturing device 502.

Next, the image capturing device 502 is described. A first arithmetic unit 504 is configured by an embedded device (for example, dedicated hardware) comprised in the image capturing device 502, and has a third parameter storage unit 509 in addition to the first parameter storage unit 105. The first arithmetic unit 504, similarly to the first embodiment, performs the convolution filter computation using the input image from the image obtaining unit 103 and the parameters stored in the first parameter storage unit 105, and transmits the result of performing a non-linear transformation on the computation result to the second arithmetic unit 107. Also, the first arithmetic unit 504, when it receives the second computation result from the second arithmetic unit 107, performs a computation using parameters stored in a third parameter storage unit 509, and obtains a final identification result (third computation result).

In the third parameter storage unit 509 information specific to the image capturing device 502 is stored. For example, in the case of implementing the previously described application for determining whether to permit a log in, official user registration information is stored in the third parameter storage unit 509. As official user registration information, the second computation result obtained by performing processing until when the second computation result is obtained on a facial image of the user when performing a user registration in advance may be used. With such a configuration, it is possible to determine whether to permit a log in by comparing the second computation result calculated at the time of user registration with the second computation result calculated at a time of log in authentication. In a case of implementing the previously described application for determining whether to permit a log in, such processing for determining whether to permit the log in is performed by the first arithmetic unit 504.

The first computation result is not made to be the registration information for the following reason. The first computation result can be said to be a local feature amount grouping because it is information based on a convolutional layer computation. Accordingly, it is difficult to authenticate fluctuations in facial expression, illumination, face direction and the like robustly simply by using the first computation result. Accordingly, it is predicted that authentication precision will improve by using the second computation result, for which a more global feature amount extraction can be expected as the registration information.

With such a configuration, it is possible to realize an image identification application that uses information specific to the image capturing device (information of an official user registered in advance in the present embodiment). While it is possible to realize the same if information specific to an image capturing device (for example, information of an official user) is also sent to an arithmetic apparatus, in such a case, that leads to an increase in the requirements in configuring the system, such as security establishment, privacy protection, and the like. Also, because first and foremost there are users who would feel uncomfortable and resist information leading to personal information being transmitted to the arithmetic apparatus, it can be expected that configuring as in the present embodiment will help to reduce the psychological resistance of users using the application.

Note that it is possible to construct an image identification system of a new configuration that appropriately combines some or all of the configurations of each embodiment described above. Also, the first arithmetic unit and the second arithmetic unit may be configured entirely by dedicated hardware (a circuit in which a processor such as a CPU and a memory such as a RAM or a ROM are arranged), but may also be configured partially by software. In such a case, the software realizes the corresponding function by being executed by a processor of the corresponding arithmetic unit. Also, all of the image identification systems described in the respective foregoing embodiments are explained as examples of an image identification system that satisfies the following requirements.
a first arithmetic apparatus that performs an arithmetic process, out of a plurality of arithmetic processes in identification processing on an input image, in which the parameter amount that is used is small compared to an amount of data to which the parameters are applied
a second arithmetic apparatus that performs an arithmetic process, out of the plurality of arithmetic processes in identification processing on an input image, in which the parameter amount that is used is large compared to an amount of data to which the parameters are applied
the second arithmetic apparatus can use a larger memory capacity memory than the first arithmetic apparatus

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-080476, filed Apr. 13, 2016, which is hereby incorporated by reference herein in its entirety.

What is claimed is:

1. An image identification system, comprising:
a first arithmetic apparatus configured to perform an arithmetic process, out of a plurality of arithmetic processes in identification processing on an input image, in which a parameter amount that is used is small compared to an amount of data to which the parameter is applied, and
a second arithmetic apparatus configured to perform an arithmetic process, out of the plurality of arithmetic processes, in which the parameter amount that is used is large compared to an amount of data to which the parameter is applied, wherein
the second arithmetic apparatus can use a larger memory capacity memory than the first arithmetic apparatus.

2. The image identification system according to claim 1, wherein the first arithmetic apparatus performs an arithmetic process in which the same first parameter is applied to respective partial images of the input image, and the second arithmetic apparatus performs an arithmetic process in which respective partial sets of a second parameter are applied to the same data.

3. The image identification system according to claim 1, wherein the arithmetic process that the first arithmetic apparatus performs is a convolution filter computation, and the arithmetic process that the second arithmetic apparatus performs is a matrix product computation.

4. The image identification system according to claim 3, wherein the first arithmetic apparatus performs a convolution filter computation using a filter kernel on the input image.

5. The image identification system according to claim 3, wherein the second arithmetic apparatus performs a matrix product computation using a computation result by the first arithmetic apparatus and a weighting coefficient parameter.

6. The image identification system according to claim 1, wherein the second arithmetic apparatus identifies a person in the input image based on a computation result.

7. The image identification system according to claim 1, wherein the second arithmetic apparatus outputs a computation result to the first arithmetic apparatus, and the first arithmetic apparatus performs an authentication of a user of the first arithmetic apparatus based on the computation result.

8. The image identification system according to claim 7, wherein the first arithmetic apparatus computes a feature amount of an image of a user, and the second arithmetic apparatus computes a high-order feature amount of the feature amount, and the first arithmetic apparatus performs an authentication of the user based on the high-order feature amount.

9. The image identification system according to claim 1, wherein
the image identification system has a plurality of the first arithmetic apparatus, and
the second arithmetic apparatus performs a computation using a result that connects results of the arithmetic process by the plurality of first arithmetic apparatuses.

10. The image identification system according to claim 9, wherein the second arithmetic apparatus performs a matrix product computation using a weighting coefficient parameter and the result that connects results of the arithmetic process by the plurality of first arithmetic apparatuses.

11. The image identification system according to claim 1, wherein the first arithmetic apparatus is an embedded device that is embedded in an image capturing device for capturing images, and the input image is an image captured by the image capturing device.
